(19) United States
(12) Patent Application Publication
(10) Pub. No.: US 2022/0056281 A1
(43) Pub. Date: Feb. 24, 2022

(54) APPLICATION OF ANTIMICROBIAL COATINGS USING ATMOSPHERIC PRESSURE PLASMA SPRAY SYSTEMS

(71) Applicant: TRITON SYSTEMS, INC., Chelmsford, MA (US)

(72) Inventors: Douglas W. FREITAG, Brookeville, MD (US); Arthur J. GAVRIN, Manchester, NH (US)

(21) Appl. No.: 17/336,921

(22) Filed: Jun. 2, 2021

Related U.S. Application Data
(60) Provisional application No. 63/034,094, filed on Jun. 3, 2020.

(51) Int. Cl. C09D 5/14; C09D 7/20; C09D 7/61; C09D 7/63; C09D 7/65; B05D 1/00; B05D 3/14; B05B 5/053; B05B 5/03

(52) U.S. Cl. CPC C09D 5/14; C09D 7/20; C09D 7/61; C09D 7/63; B05B 5/03; B05D 1/62; B05D 3/142; B05B 5/0533; C09D 7/65

(57) ABSTRACT

Devices and methods are provided to apply thin layers of antimicrobial coatings onto a wide variety of substrates and articles. The methods can be performed at moderate temperatures and pressures, allowing for the coating of sensitive substrates and articles.

### CROSS REFERENCE TO RELATED APPLICATIONS

This application claims priority to U.S. Provisional Application Ser. No. 63/034,094 filed on Jun. 3, 2020, the content of which is hereby incorporated by reference in its entirety.

### STATEMENT REGARDING FEDERALLY SPONSORED RESEARCH OR DEVELOPMENT

This invention was made with government support under contract funding number W91-INF-07-C-0023 awarded by the Defense Advanced Research Projects Agency (DARPA). The United States government has certain rights in the invention.

### BACKGROUND

Antimicrobial coatings are fairly common, and are used to confer resistance against bacterial, fungal, and viral contamination. Antimicrobial agents can be typically sprayed onto an article, or can be incorporated throughout the article itself.

Despite the many antimicrobial coatings in use, there still exists for efficient and safe methods to apply coatings to sensitive substrates such as electronics and optics without adversely affecting the performance and appearance of the sensitive substrates.

### SUMMARY

In one embodiment, a method of applying an antimicrobial coating onto an article is provided, the method comprising: providing an uncoated article; providing a liquid solution comprising at least one antimicrobial agent and at least one solvent; and applying the liquid solution onto the article using atmospheric pressure plasma processing to produce a coated article.

In another embodiment, a coated article is provided, where the coated article is prepared by a method comprising: providing an uncoated article; providing a liquid solution comprising at least one antimicrobial agent and at least one solvent; and applying the liquid solution onto the article using atmospheric pressure plasma processing to produce the coated article.

In a further embodiment, a device for applying an antimicrobial coating onto an article is provided, the device comprising: at least one liquid solution reservoir; at least one nebulizer; at least one fluid pump; at least one gas tank configured to supply carrier gas and plasma discharge gas; at least one atmospheric pressure plasma discharger; at least one nozzle with atmospheric pressure plasma dischargers either in a fixed position or at the end of a flexible trunk; and at least one a variable power supply to provide pulsed or static high voltage.

### BRIEF DESCRIPTION OF THE DRAWINGS

FIG. 1 shows a schematic of an Atmospheric Pressure Plasma Liquid Deposition “APPLD” electrode assembly.

### DETAILED DESCRIPTION

This disclosure is not limited to the particular systems, devices and methods described, as these may vary. The terminology used in the description is for the purpose of describing the particular versions or embodiments only, and is not intended to limit the scope.

Methods of Coating Articles

In some examples, methods are described to apply an antimicrobial coating onto an article. The method can comprise providing an uncoated article; providing a liquid solution comprising at least one antimicrobial agent and at least one solvent; and applying the liquid solution onto the article using atmospheric pressure plasma processing to produce a coated article.

The methods do not require harsh, corrosive chemicals and do not generate hazardous waste streams, thereby making the methods relatively environmentally and substrate friendly.

The article can generally be any article to which applying an antimicrobial coating is desired. Examples of articles include electronic components, electronic devices, mobile telephones, handheld GPS units, 2-way radios, navigation electronics devices, electronic switches, remote controls, household fixtures such as handles and knobs, musical electronics, optical glass, optical components, eyeglasses, telescopes, food packaging, and so on. Other examples include printed circuit boards, radiofrequency transparent materials, optically transparent materials, leather, animal hides, furniture, furniture coverings, touch screen surfaces, home gaming systems, home gaming controllers, and so on.

The article can generally be made of any material or two or more different materials. For example, the article can be made of metal, ceramic, plastics, siloxane, fabric, paper, woven or nonwoven fibers, natural fibers, synthetic fibers cellulosic material and powder. In some examples, the article is made of a plastic material, for example thermoplastics such as polyolefins, polyethylene, and polypropylene, polycarbonates, polyurethanes, polyvinylchloride, polyesters (for example polyalkylene terephthalates, particularly polyethylene terephthalate), polymethacrylates (for example polymethylmethacrylate and polymers of hydroxyethylmethacrylate), polyepoxides, polysulfones, polyphenylenes, polyetherketones, polyimides, polyamides, polystyrenes, phenolic, epoxy and melamine-formaldehyde resins, and blends and copolymers thereof.

The antimicrobial agent can generally be any antimicrobial agent. Examples of antimicrobial agents include cationic surfactants (quaternary ammonium salts), chlorhexidine gluconate, metal nanoparticles (silver or copper, for example), triclosan, zinc dioxide, N-halamine, and poly(hexamethylene biguanide) hydrochloride (PHMB).

he solvent can be a single solvent or a combination of two or more solvents. Examples of solvents include alcohols, methanol, ethanol, 2-propanol, 1-propanol, 1-butanol, glycols, ethylene glycol, and so on. In some examples, the solvent is at least one alcohol, at least one glycol, or a combination thereof.

The liquid solution can further comprise at least one coating matrix. The coating matrix can be a polymer resin, an oligomer, a monomer, or an inorganic matrix former (such as a metal alkoxide, for example).

The monomer can generally have any reactive group suitable for polymerization. For example, the monomer can be a free-radical initiated polymerizable monomer. The monomer can have at least one unsaturated group such as a linear alkenyl group, a branched alkenyl group, a vinyl group, a propenyl group, a hexenyl group, or an alkynyl group. The monomer can also contain at least one other type of functional group which is not polymerized via a free-radical polymerization process, Such groups may include, alcohol groups, carboxylic acid groups, carboxylic acid derivative groups such as aldehydes and ketones, esters, acid anhydrides, maleates, amides and the like, primary secondary or tertiary amino groups, alkylhalide groups, carbamate groups, urethane groups, glycidyl and epoxy groups, glycol and polyglycol groups, organic salts, organic groups containing boron atoms, phosphorus containing groups such as phosphonates, and sulfur containing groups such as mercapto, sulfido, sulfone, and sulfonate groups, and grafted or covalently bonded biochemical groups such as amino acids and/or their derivatives, grafted or covalently bonded bio chemical species such as proteins, enzymes and DNA. Since the plasma process is of a “soft ionization' type, the latter groups are not destroyed and therefore provide functionality to the resulting polymer coating on the article's surface.

Specific examples of monomers include methacrylic acid, acrylic acid, alkylacrylic acid, fumaric acid and esters, maleic acid, maleic anhydride, citraconic acid, cinnamic acid, itaconic acid (and esters), vinylphosphonic acid, sorbic acid, mesaconic acid, citric acid, succinic acid, ethylenediamine tetracetic acid (EDTA), ascorbic acid and their derivatives, and/or unsaturated primary or secondary amine. For example, allylamine, 2-aminoethylene, 3-aminopropylene, 4-aminobutylene and 5-aminopentylene acrylonitrile, methacrylonitrile, acrylamide, N-isopropylacrylamide, methacrylamide, epoxy compounds, for example allylglycidylether, butadiene monoxide, 2-propene-1-ol, 3-allyloxy-1.2.-propanediol, vinylcyclohexene oxide, and phosphorus-containing compounds, for example dimethylvinylphosphonate, diethyl allyl phosphate and diethyl allylphosphonate, vinyl sulfonic acid, phenylvinylsulfonate, and vinylsulfone.

Other examples of monomers include methacrylates, acrylates, diacrylates, dimethacrylates, styrenes, methacrylonitriles, alkenes and dienes, for example methyl methacrylate, ethyl methacrylate, propyl methacrylate, butyl methacrylate, and other alkyl methacrylates, and the corresponding acrylates, including organofunctional methacrylates and acrylates, including glycidyl methacrylate, trimethoxysilyl propyl methacrylate, allyl methacrylate, hydroxyethyl methacrylate, hydroxypropyl methacrylate, dialkylaminoalkyl methacrylates, and fluoroalkyl (meth) acrylates, and styrene, C.-methylstyrene, halogenated alkenes, for example, vinylidene halides, vinyl halides, such as vinyl chlorides and vinyl fluorides, and fluorinated alkenes, for example perfluoroalkenes.

Antimicrobial refers to being inhibiting or destroying the viability of one or more microbes. Example classes of microbes include bacteria, fungi, and viruses. Antimicrobial properties can be measured in a variety of manners such as counting colony forming units (cfu) or plaque forming units (pfu) before and after contact, or against a control. Potentially harmful bacteria include campylobacter, salmonella, Streptococcus, Group A Streptococcus, Streptococcus pneumoniae, Streptococcus pyogenes, Streptococcus pharyngitis, Staphylococcus aureus, Pseudomonas aeruginosa, Clostridium perfringens, Clostridium botulinum, Listeria, Escherichia coli, Bacillus cereus, Shigella, and Vibrio parahaemolyticus. Potentially harmful fungi include fusarium, Stachybotrys, Aspergillus flavus, and Candida. Potentially harmful viruses include Marburg, Ebola, Rabies, HIV, smallpox, hantavirus, influenza, dengue, rotavirus, SARS-CoV, SARS-CoV-2, MERS-CoV, Zika, H1N1, H5N1, Lassa, Junin, Crimea-Congo fever virus, Machupo virus, and Kyasanur Forest Virus.

The coating can generally be of any thickness. For example, the thickness can be at least about 10 nm, about 10 nm to about 250 nm, about 10 nm to about 100 nm, or about 60 nm to about 120 nm. Specific examples of the coating thickness include about 10 nm, about 25 nm, about 50 nm, about 75 nm, about 100 nm, about 125 nm, about 150 nm, about 175 nm, about 200 nm, about 225 nm, about 250 nm, and ranges between any two of these values. The coating can be applied in a single pass or can be applied in multiple passes. For example, a single pass of 10 nm to 20 nm can be applied once or in multiple passes to build a thicker coating. For example, five passes could generate a coating of 50 nm to 100 nm thick, or six passes could generate a coating of 60 nm to 120 nm thick.

The antimicrobial coating can generally be any antimicrobial coating, such as a free-radical polymerized polymeric coating. The liquid solution can further comprise at least one catalytically active initiator. Surprisingly, the initiator also increases the degree to which the functionality of the monomer is retained within a plasma polymerized coating subsequent to polymerization.

Specific examples of initiators include hydrogen peroxide and families of peroxides such as: i) diacyls, for example benzoyl peroxide; lauroyl peroxide; decanoyl peroxide and 3,3,5-trimethylhexanoyl peroxide; ii) peroxydicarbonates, for example di-(2-ethylhexyl)peroxydicarbonate; iii) monoperoxycarbonates, for example poly(tert-butyl peroxycarbonate), and 00-tert-butyl-O-(2-ethylhexyl) monoperoxycarbonate; iv) peroxyketals, for example ethyl 3,3-di(tert-butylperoxy)butyrate; n-butyl 4,4-di-tert-(tert-butylperoxy)valerate; 2.2-di(tert-butylperoxy)butane; 1,1-di(tert-butylperoxy)cyclohexane and 1,1-di(tert-amylperoxy)cyclohexane: V) peroxyesters, for example tert-butyl peroxybenzoate: tert-butyl peroxyacetate; tert-butyl peroxy-3.5.5-trimethylhexanoate: tert-amyl peroxy-3.5.5-trimethylhexanoate; tert-butyl peroxyisobutyrate; tert-butyl peroxy-2-ethylhexanoate: tert-butyl peroxypivalate; tert-amylperoxypivalate; tert-butyl peroxyneodecanoate; tert amyl peroxyneodecanoate; cumyl peroxyneodecanoate: 3-hydroxy-1,1-di-methylbutylperoxyneodecanoate: vi) dialkyls, for example 2,5-dimethyl2,5-di(tert-butylperoxy)hexyne; di-tert-butyl peroxide; di-tert-amyl peroxide; 2,5-dimethyl-2,5-di(tert-butylperoxy)hexane: dicumyl peroxide; and vii) hydroperoxides, for example tert-butyl hydroperoxide: tert-amyl hydroperoxide; cumene hydroperoxide; 2.5-dimethyl-2,5-di(hydroperoxide) hexane; diisopropyl benzene monohydroperoxide; and paramenthane hydroperoxide.

Other initiators include hydrazines, polysulfides, azo-compounds, for example azobisisobutyronitrile, metal iodides, and metal alkyls, benzoins, benzoin ethers such as benzoin alkyl ethers and benzoin aryl ethers, acetophenones, benzil, benzil ketals, such as benzil dialkyl ketal, anthraquinones such as 2-alkylanthraquinones, 1-chloroanthraquinones and 2-amylanthraquinone, triphenylphosphine, benzoylphosphine oxides, benzophenones, thioxanones, xanthones, acridine derivatives, phenzine derivatives, quinoxaline derivatives, phenylketones Such as 1-aminophenylketones and 1-hydroxyphenylketones Such as 1-hydroxycyclohexylphenylketone and triazine compounds.

The monomer and initiator may be premixed and contact the atmospheric plasma together. The monomer and initiator can be in the form of a gaseous mixture or in the form of a mixed atomized liquid. Alternatively, they may be introduced into a plasma chamber separately and contact the atmospheric pressure plasma separately at an appropriate rate.

A plasma is defined as a partially or fully ionized gas. Most commonly plasmas are generated at low pressures in a vacuum system. There is, however, a class of plasmas which can be generated at atmospheric pressure, avoiding the need for expensive vacuum systems and transfer chambers to atmospheric pressures. These atmospheric plasmas are relatively low in temperature, less than or equal to 150° C., which allows for their use on temperature sensitive materials, such as polymers.

An atmospheric pressure plasma discharge can be generated by generally any suitable method. Examples include atmospheric pressure plasma jet, atmospheric pressure microwave glow discharge, or atmospheric pressure glow discharge. In certain examples, an atmospheric pressure plasma discharge can be created using helium diluents, argon gas, or nitrogen gas and a high frequency power supply (for example, greater than 1 kHz) to generate a homogeneous glow discharge at atmospheric pressure.

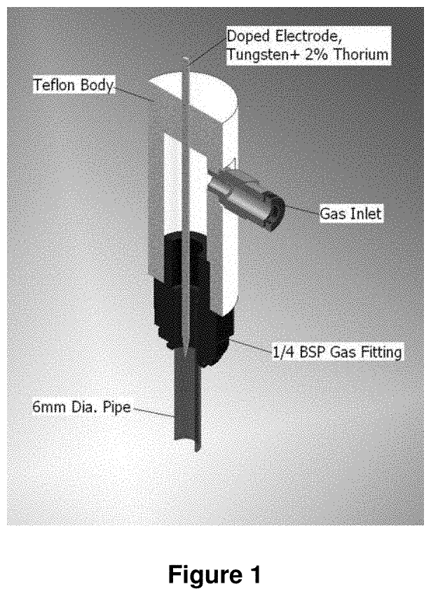

One variation of atmospheric pressure plasma was developed by Dow-Corning in Ireland (L. O'Neill, L.-A. O'Hare, S. R. Leadley, and A. J. Goodwin, “Atmospheric Pressure Plasma Liquid Deposition—A Novel Route to Barrier Coatings,” Chem. Vap. Depos., vol. 11, no. 11-12, pp. 477-479, December 2005). The system injects a liquid into the plasma, depositing a coating onto a substrate. The procedure is named “Atmospheric Pressure Plasma Liquid Deposition” (“APPLD”). A schematic of the APPLD electrode assembly used to generate the aerosol and plasma is presented in FIG. 1. The Figure shows a number of attractive features, such as a robust and compact design, use of a pin electrode to create plasma, no need for a counter electrode to prevent arc formation, a dielectric Teflon housing, pre-mixing of gas and aerosol before entry into the device, and exit of plasma through the bottom pipe. While the figure illustrates the use of a single pin electrode and a Teflon housing, use of dual electrodes and/or ceramic or other housing materials are also suitable. The components of FIG. 1 are: a Teflon body, a doped electrode (such as tungsten with 2% thorium), a gas inlet, a gas fitting (such as a ¼ BSP gas fitting), and an outlet pipe (such as a 6 mm diameter outlet pipe).

The applying step can comprise aerosolizing the liquid solution to form an aerosolized liquid solution and exposing the aerosolized liquid solution to an atmospheric pressure plasma discharge. Depositing the antimicrobial agent by atmospheric pressure plasma liquid deposition allows for simultaneous surface activation and enhanced sterilization speed, and matrix polymerization through the formation of free electrons and free radical moieties that both act as antimicrobials, as well as induce polymerization of constituent species in the aerosolized liquid. Due to the low temperature of the atmospheric pressure plasma liquid deposition plasma, the resultant coating may contain bound or leaching antimicrobial species that confer improved antimicrobial properties.

he aerosolizing step can be performed by generally any suitable method. For example, aerosolizing can be performed using an ultrasonic nozzle that produces droplets. The droplets can be characterized by their average particle size. Example ranges of average droplet particle sizes include about 10 μm to about 100 μm or about 10 μm to 50 μm. Specific examples of average droplet particle sizes include about 10 μm, about 20 μm, about 30 μm, about 40 μm, about 50 μm, about 60 μm, about 70 μm, about 80 μm, about 90 μm, about 100 μm, and ranges between any two of these values.

The method can further comprise pre-treating, such as plasma cleaning, activating, or both, a surface of the article before the applying step. For example, a helium gas plasma can be used to clean, activate, or both, a surface of the article. In some examples, only a portion of the outer surface of the article can be pre-treated, or the entire outer surface of the article can be pre-treated.

Alternatively, pre-treating can include oxidizing a surface of the article before the applying step. For example, oxidizing can include treating with an oxygen/helium process gas. Oxidizing pretreatments include peroxides, water, or alcohol, with or without plasma These can enhance the bonding of the resin to the surface, especially on textiles. The specific treatment/surface cleaning will be selected based upon the substrate.

Coated Articles

In some examples, coated articles are described. The coated articles can be prepared by any of the above-described methods. For example, a coated article can be prepared by the method comprising providing an uncoated article; providing a liquid solution comprising at least one antimicrobial agent and at least one solvent; and applying the liquid solution onto the article using atmospheric pressure plasma processing to produce the coated article.

Coating Devices

In some examples, devices are described that are useful to apply the above-described coatings onto articles. The device can comprise at least one liquid solution reservoir; at least one nebulizer; at least one fluid pump; at least one gas tank configured to supply carrier gas and plasma discharge gas; at least one atmospheric pressure plasma discharger; at least one nozzle with atmospheric pressure plasma dischargers either in a fixed position or at the end of a flexible trunk; and at least one a variable power supply to provide pulsed or static high voltage.

The device can be fixed in place, with a chamber into which an article to be coated is placed. Alternatively, the device or portion thereof can be moveable, allowing for hand-coating of an article or surface. For example, the device can be packaged into a backpack or other moveable bag or can be mounted on wheels or a moveable cart. Portable devices can be attractive for spot coating or other small coating tasks. A wheel mounted system allows for larger systems to remain portable, and to perform more coatings between needing to refill or recharge the device.

In some examples, the device can include a power supply, a gas supply, a liquid supply, and a handheld nozzle with gas, liquid and power feeds. The gas can be stored in a pressure cylinder. The liquid (solvent and active biocides) can be stored in containers such as plastic containers. The power supply can generally be any type of power supply, such as a battery or plug-in utility.

### EXAMPLES

### Example 1

### Application of Self-Decontaminating Surface Coating

A liquid coating formulation was prepared by mixing 4% polyhexamethylene biguanide (PHMB), 5% epoxy silane, 3% resorcinol diglycidyl ether, 2.5% ethylene glycol and 85.5% ethanol solvent. The coating formulation was applied onto sensitive electronics including circuit boards and optical glasses using an SE-2100 PlasmaStream device, a portable APPLD coater device. The He/N₂ gas flow rate was 0.5 L/minute. The liquid flow rate was 10 μL/minute. The distance from nozzle to the substrate was about 1 mm to 10 mm. FIG. 2(A) shows (from top to bottom) handheld GPS units, circuit boards, and optical glass.

The coating did not affect the performance or appearance of the coated electronics. The coating was approximately 120 nm thick.

### Example 2

### Anti-Microbial Testing of Surface Coatings

The coating from Example 1 was challenged with about 10⁴ CFU/cm² of dry Bacillus globigii spores (Gram-positive bacteria). A 1.54 log reduction in viable spores was observed after 24 hours of contact.

A similar challenge with a liquid application of Staphylococcus aureus (Gram-positive bacteria) showed a greater than 2.7 log reduction after 1 hour of contact. No viable E. coli bacteria were detected.

### Example 3

### Device for Applying Antimicrobial Coatings

A device can be designed and constructed to facilitate application of self-decontaminating surface coatings. The device includes at least one liquid solution reservoir; at least one nebulizer; at least one fluid pump; at least one gas tank configured to supply carrier gas and plasma discharge gas; at least one atmospheric pressure plasma discharger; at least one nozzle with atmospheric pressure plasma dischargers either in a fixed position or at the end of a flexible trunk; and at least one a variable power supply to provide pulsed or static high voltage. The device will either be configured to fit into a backpack, or to be mounted on wheels.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of applying an antimicrobial coating onto an article, the method comprising:
providing an uncoated article;
providing a liquid solution comprising at least one antimicrobial agent and at least one solvent; and
applying the liquid solution onto the article using atmospheric pressure plasma processing to produce a coated article.

2. The method of claim 1, wherein the article is an electronic component, an electronic device, a mobile telephone, a handheld GPS unit, a 2-way radio, a navigation electronic device, a musical electronic, an optical glass, an optical component, eyeglasses, a telescope, or food packaging.

3. The method of claim 1, wherein the article is made of metal, ceramic, plastic, siloxane, fabric, paper, woven or nonwoven fibers, natural fibers, synthetic fibers cellulosic material, powder, plastic material, thermoplastic, polyolefins, polyethylene, polypropylene, polycarbonate, polyurethane, polyvinylchloride, polyester, polyalkylene terephthalates, particularly polyethylene terephthalate, polymethacrylate, polymers of hydroxyethylmethacrylate, polyepoxides, polysulfones, polyphenylenes, polyetherketones, polyimides, polyamides, polystyrenes, phenolic, epoxy and melamine-formaldehyde resins, or blends or copolymers thereof.

4. The method of claim 1, wherein the antimicrobial agent is a cationic surfactant, a quaternary ammonium salt, chlorhexidine gluconate, a metal nanoparticle, silver nanoparticle, copper nanoparticle, triclosan, zinc dioxide, N-halamine, or poly(hexamethylene biguanide) hydrochloride (PHMB).

5. The method of claim 1, wherein the solvent is at least one alcohol, at least one glycol, or a combination thereof.

6. The method of claim 1, wherein the liquid solution further comprises at least one coating matrix.

7. The method of claim 1, wherein the liquid solution further comprises at least one polymer resin, at least one oligomer, at least one monomer, or at least one inorganic matrix former.

8. The method of claim 1, wherein the liquid solution further comprises at least one catalytically active initiator.

9. The method of claim 7, wherein the initiator is hydrogen peroxide, a diacyl, a peroxydicarbonate, a monoperoxycarbonate, a peroxyketal, a peroxyester, a dialkyl, or a hydroperoxide.

10. The method of claim 7, wherein the initiator is a hydrazine, a polysulfide, an azo-compound, a metal iodide, a metal alkyl, a benzoin, a benzoin ether, a benzoin aryl ether, an acetophenone, benzil, a benzil ketal, an anthraquinone, a triphenylphosphine, a benzoylphosphine oxide, a benzophenone, a thioxanone, a xanthone, an acridine derivative, a phenzine derivative, a quinoxaline derivative, a phenylketone, a 1-hydroxyphenylketone, or a triazine.

11. The method of claim 7, wherein the monomer and the initiator contact the atmospheric pressure plasma together.

12. The method of claim 7, wherein the monomer and the initiator contact the atmospheric pressure plasma separately.

13. The method of claim 1, wherein the atmospheric pressure plasma processing is performed at a temperature of less than or equal to 150° C.

14. The method of claim 1, wherein the atmospheric pressure plasma processing is performed by atmospheric pressure plasma jet, atmospheric pressure microwave glow discharge, or atmospheric pressure glow discharge.

15. The method of claim 1, wherein the atmospheric pressure plasma processing is atmospheric pressure plasma liquid deposition (APPLD).

16. The method of claim 1, wherein the applying step comprises aerosolizing the liquid solution to form an aerosolized liquid solution, and exposing the aerosolized liquid solution to an atmospheric pressure plasma discharge.

17. The method of claim 1, further comprising pre-treating a surface of the article before the applying step.

18. The method of claim 1, further comprising plasma cleaning a surface of the article before the activating step.

19. The method of claim 1, further comprising oxidizing a surface of the article before the activating step.

20. The method of claim 1, wherein the antimicrobial agent inhibits or destroys the viability of bacteria, fungi, viruses, or a combination thereof.

21. A coated article prepared by a method comprising:
providing an uncoated article;
providing a liquid solution comprising at least one antimicrobial agent and at least one solvent; and
applying the liquid solution onto the article using atmospheric pressure plasma processing to produce the coated article.

22. A device for applying an antimicrobial coating onto an article, the device comprising:
at least one liquid solution reservoir;
at least one nebulizer;
at least one fluid pump;
at least one gas tank configured to supply carrier gas and plasma discharge gas;
at least one atmospheric pressure plasma discharger;
at least one nozzle with atmospheric pressure plasma dischargers either in a fixed position or at the end of a flexible trunk; and
at least one a variable power supply to provide pulsed or static high voltage.
